(19) United States
(12) Patent Application Publication
(10) Pub. No.: US 2001/0054336 A1
(43) Pub. Date: Dec. 27, 2001

(54) Pliers for removing studs and the like

(76) Inventor: Mitchell R. Eidson, Salisbury, NC (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/883,620

(22) Filed: Jun. 18, 2001

Related U.S. Application Data
(60) Provisional application No. 60/213,503, filed on Jun. 22, 2000.

(51) Int. Cl. B25B 7/02

(52) U.S. Cl. 81/426.5

(57) ABSTRACT

A preferred embodiment of the pliers includes a handle and a jaw, with the handle incorporating a first arm and a second arm and the jaw incorporating a first jaw member and a second jaw member. The first arm, second arm, first jaw member and second jaw member cooperate with each other in a conventional scissors-like manner. Preferably, the jaw also includes a first stud-receiving area, which is defined by first and second opposing and arcuately shaped recesses, which is adapted to receive and engage a stud to be removed.

### CROSS-REFERENCE TO RELATED APPLICATION

The present application claims the benefit of and priority to U.S. Provisional Patent Application No. 60/213,503, filed Jun. 22, 2000, which is incorporated herein in its entirety.

### BACKGROUND OF THE INVENTION

1. Field of the Invention

The present invention generally relates to tools and, in particular, to pliers which are adapted for removing studs and the like.

2. Description of the Related Art

In many fields, such as automotive engine repair, for example, oftentimes it is necessary to remove studs from a component, such as from an exhaust manifold of an automobile, for instance. As used herein, the term “stud” is used to refer to either a threaded bolt without a head or to a threaded bolt incorporating a head which has been rounded or broken off. Studs come in various sizes and typically may range in diameter from eight (8) millimeters to one half (½) an inch or greater, and also may vary in length such as between one and one half (1½) inches to three and one half (3½) inches in length in a typical application. One such typical application includes the use of studs in automotive exhaust manifolds, whereby the studs typically may extend some three (3) inches from the manifold when threaded therein; however, when broken, may extend one quarter (¼) inch or less from the exhaust manifold. When a stud is broken in such a manner, removal and replacement of the stud is oftentimes required. Additionally, studs typically are removed when they deteriorate, such as by oxidation due to salt impregnation, when stud is no longer properly matable with a threaded nut, or when the stud becomes thin, e.g., so that it will no longer support a nut.

Heretofore, when it is required that such a stud is to be removed, tools such as a cylinder remover and a round remover have been utilized. As is known, however, these tools inherently suffer from several disadvantages including, in regard to the cylinder remover, that such a remover oftentimes breaks, lacks a tension feel, and is only sized for a particular size of stud; and, in regard to the round remover, it is oftentimes too large in diameter for the space available for stud removal, and oftentimes creates stud breakage as tension applied by the round remover is offset from a center of the tool.

In light of the aforementioned deficiencies of the prior art stud removers, common electrical pliers also have been utilized to remove broken studs. However, this tool suffers from the deficiency of incorporating a substantially flat engagement surface for grasping the substantially rounded exterior surface of the broken stud, thereby resulting in a less then desirable gripping of the stud for removal.

Therefore there is a need for improved devices and methods which address these and other short comings of the prior art.

### SUMMARY OF THE INVENTION

Briefly described, the present invention generally relates to tools and, in particular, to pliers which are adapted for removing studs and the like. A preferred embodiment of the pliers includes a handle and a jaw, with the handle incorporating a first arm and a second arm and the jaw incorporating a first jaw member and a second jaw member. The first arm, second arm, first jaw member and second member jaw include means to cooperate with each other in a conventional scissors-like manner. Preferably, the jaw also include means to engage or receive studs. In the preferred embodiment, the means to engage or receive studs includes stud-receiving areas, which are defined by first and second opposing and arcuately shaped recesses, which are adapted to receive and engage a stud to be removed.

Other features and advantages of the present invention will become apparent to one with skill in the art upon examination of the following drawings and detailed description. It is intended that all such features and advantages be included herein within the scope of the present invention, as defined in the appended claims.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a partially cut-away side view of a preferred embodiment of the present invention in a closed position.

FIG. 2 is a partially cut-away side view of the embodiment depicted in FIG. 1 shown in an open position.

FIG. 3 is an end view of the embodiment of FIGS. 1 and 2 shown in the closed position.

FIG. 4 is an end view of the embodiment depicted in FIGS. 1-3 shown in the open position.

FIG. 5 is a partially cut-away plan view of the embodiment depicted in FIG. 1, as viewed along section lines 5-5, showing detail of a preferred jaw of the present invention.

### DETAILED DESCRIPTION OF THE PREFERRED EMBODIMENT

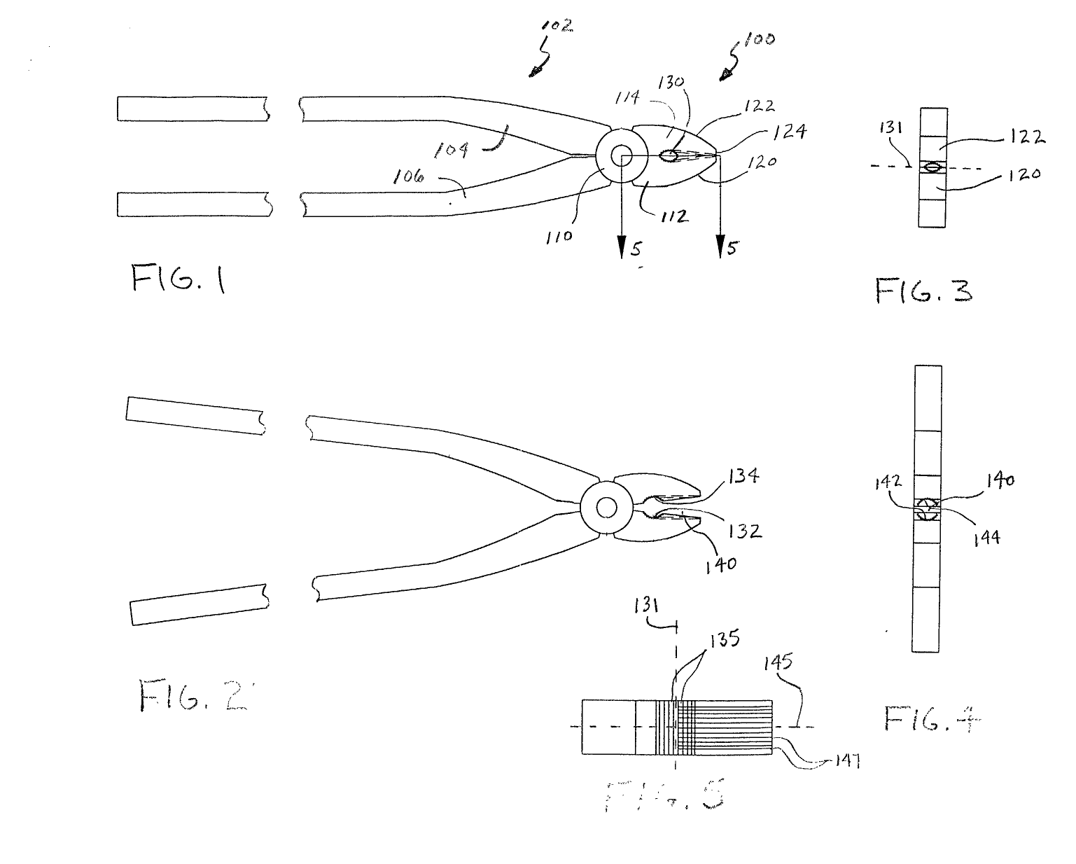

Reference will now be made in detail to the description of the invention as illustrated in the drawings with like numerals indicating like parts throughout the several views. As shown in FIG. 1, pliers 100 include a handle 102 which incorporates a first arm 104 and a second arm 106. The pliers 100 also includes jaws 112 and 114. In the preferred embodiment the arms 104 and 106 and jaw members 112 and 114 are connected and include a means for operating the arms 104 and 106 and jaws 112 and 114 in a scissors like fashion. In the preferred embodiment depicted in FIG. 1, arms 104 and 106 cooperate with respective jaw members 112 and 114 and are mated at their proximal ends by a fulcrum 110 which facilitates a scissors-like motion of the arms 104 and 106 and jaws 112 and 114. So configured, movement of the distal ends of the arms away from each other repositions the jaws to an open position, such as depicted in FIG. 2. Preferably, each of the arms 104 and 106 is configured as an elongated member which is well suited to be grasped by an operator, with each arm 104 and 106 possessing a sufficient length to generate a suitable amount of leverage for imparting a grasping force, through the jaws 112 and 114, to a stud to be removed. For example, and not for the purpose of limitation, an arm length of approximately sixteen (16) inches has been determined to be appropriate in some applications. Such a conventional scissors-like configuration as depicted in the preferred embodiment of FIG. 1 also provides an operator with an appropriate feedback or tension control so that the operator may have a keen awareness of how much force is being exerted to the stud to be removed.

Referring now to FIGS. 1 and 3, the jaws 112 and 114 will now be described in greater detail. As shown most clearly in FIG. 1, each jaw 112 and 114 has an outer surface, surfaces 120 and 122, respectively, which preferably is arcuately shaped and which tapers inwardly from the fulcrum 110 to the nose 124 of the pliers. In the preferred embodiment, the jaws 112 and 114 include means for engaging or receiving a stud when said jaws 112 and 114 are in a closed position or operated towards a closed position. In the preferred embodiment the means for engaging or receiving a stud includes a first stud-receiving area 130 formed along a transverse 131 axis of the jaws 112 and 114 and is defined by surfaces 132 and 134 respectively. Preferably, the surfaces 132 and 134 are formed as cylindrical sectors which incorporate axial grooves 135 for improving gripping engagement of the surfaces 132 and 134 about a stud. So configured, studs of various diameters and lengths may be removed by placing the stud within the area 130 and then clamping the surfaces 132 and 134 about the exterior of the stud so that a longitudinal axis of the stud is substantially aligned with axis 131 of area 130. The degree of curve of the surfaces 132 and 134 will vary in different embodiments, and in the preferred embodiment the degree of curve will be sufficient to allow the manipulation of studs from eight millimeters (8 mm) to one-half inch (½ in) or more in diameter. However, as would be known to one skilled in the art, a greater or smaller degree of curvature of the surfaces 132 and 134 may be implemented for use with studs of other sizes.

Referring now to FIGS. 4 and 5, in the preferred embodiment, the means for engaging or receiving a stud with the jaws 112 and 114 when the jars are closed or operated towards a closed position further includes a second stud engagement area 140. As shown in FIGS. 4 and 5, the second stud engagement area 140 is preferably defined by engagement surfaces 142 and 144 which are arranged substantially parallel to a longitudinal axis 145 of the pliers. Each engagement surface 142 and 144 preferably defines a sector of a cylinder and, thus, is suitably adapted for engaging the exterior surface of a stud to be removed when the longitudinal axis of the stud is arranged substantially parallel to the longitudinal axis 145 of the pliers. The degree of curve of the surfaces 142 and 144 will vary in different embodiments, and in the preferred embodiment the degree of curve will be sufficient to allow the manipulation of studs from eight millimeters (8 mm) to one-half inch (½ in) or more in diameter. However, as would be known to one skilled in the art, a greater or smaller degree of curvature of the surfaces 142 and 144 may be implemented for use with studs of other sizes. As described hereinbefore in relation to the first engagement area 130, the engagement surfaces 142 and 144 also may incorporate a grooved configuration, with grooves 147 enhancing the engagement of the pliers with the stud to be removed. Additionally, the engagement surfaces 142 and 144 allow an increased surface area of the exterior of a stud to be engaged as compared to the amount of surface engaged by pliers incorporating flattened jaws, thereby further facilitating convenient removal of the stud.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

I claim:

1. Pliers for removing studs comprising:
a handle having a first arm and a second arm, said first arm having a proximal end and a distal end, said second arm having a proximal end and a distal end; and
a jaw having a first jaw member and a second jaw member, said first jaw member having a proximal end and a distal end, said proximal end of said first jaw member engaging said proximal end of said first arm, said second jaw member having a proximal end and a distal end, said proximal end of said second jaw member engaging said proximal end of said second arm;
said first arm, said second arm, said first jaw member and said second jaw member cooperating such that said arms and said jaw members operate in a scissors-like manner;
said jaw having a first stud-receiving area formed therein, said first stud-receiving area being defined by first and second opposing and arcuately shaped recesses, said first recess being formed by said first jaw member, said second recess being formed by said second jaw member.

2. The pliers of claim 1, wherein said first stud-receiving area is formed parallel to a transverse axis of said pliers.

3. The pliers of claim 2 wherein said first and second opposing and arcuately shaped recesses include grooves in the recesses, said grooves formed parallel to said transverse axis of said pliers

4. The pliers of claim 1, wherein said jaw has a second stud receiving area formed therein, said second stud-receiving area being defined by third and fourth opposing and arcuately shaped recesses, said third recess being formed by said first jaw member, said fourth recess being formed by said second jaw member.

5. The pliers of claim 4, wherein said second stud-receiving area is formed parallel to a longitudinal axis of said pliers.

6. The pliers of claim 5, wherein said second stud-receiving area includes grooves, said grooves being formed parallel to said longitudinal axis.

7. A tool for removing studs comprising:
a first arm portion having a proximal end and a distal end;
a second arm portion having a proximal end and a distal end;
a first jaw portion having a proximal end and a distal end, said proximal end of said first jaw portion being connected to said proximal end of said first arm portion;
a second jaw portion having a proximal end and a distal end, said proximal end of said second jaw portion being connected to said proximal end of said second arm portion; and
a stud-engaging area formed parallel to a longitudinal axis of said pliers, said stud-engaging area being defined by a first and a second opposing recess, said first recess being formed by said first jaw portion, said second recess being formed by said jaw portion;
said first arm portion, said second arm portion, said first jaw portion, and said second jaw portion cooperating such that said arms and said jaw portions operate in a scissors-like manner.

8. Pliers for removing studs comprising:
a handle, said handle having a first arm part and a second arm part;
a jaw, said jaw having a first jaw part and a second jaw part;
means for operating said arm parts and said jaw parts in a scissors-like manner; and
means for engaging a stud with said jaw parts when said jaw parts are operated towards a closed position.

9. The pliers of claim 8, wherein said means for engaging a stud with said jaw parts comprises a first stud receiving portion, said first stud-receiving portion being defined by first and second opposing shaped recesses, said first recess being formed by said first jaw part, said second recess being formed by said second jaw part.

10. The pliers of claim 9, wherein said first stud-receiving portion is formed parallel to a transverse axis of said pliers.

11. The pliers of claim 10, wherein said means for engaging a stud with said jaw parts further comprises a second stud-receiving portion, said second stud-receiving portion being defined by first and second opposing shaped recesses, said first recess being formed by said first jaw part, said second recess being formed by said second jaw part.

12. The pliers of claim 11, wherein said second stud-receiving portion is formed parallel to a longitudinal axis of said pliers.
